(19) United States
(12) Patent Application Publication
(10) Pub. No.: US 2017/0271745 A1
(43) Pub. Date: Sep. 21, 2017

(54) ANTENNA COVER HAVING A THERMAL BARRIER

(71) Applicant: TYCO ELECTRONICS CORPORATION, Berwyn, PA (US)

(72) Inventors: Hyo Chang Yun, Saratoga, CA (US); Kathleen Fasenfest, Union City, CA (US); Thomas D. Ratzlaff, Menlo Park, CA (US); Lei Wang, San Jose, CA (US); Ismael L. Sandoval, Fremont, CA (US)

(21) Appl. No.: 15/072,704

(22) Filed: Mar. 17, 2016

(51) Int. Cl. H01Q 1/02; H01Q 1/28; H01Q 1/40

(52) U.S. Cl. CPC H01Q 1/02; H01Q 1/40; H01Q 1/28

(57) ABSTRACT

An antenna cover for an antenna of an aircraft includes a thermal barrier having an aerogel blanket having a shape of the antenna cover. The aerogel blanket has an inner side and an outer side with edges therebetween. The inner side is configured to face the antenna. The antenna cover includes a cover layer applied to the aerogel blanket. The cover layer includes at least one polytetrafluoroethylene (PTFE) sheet being a structurally reinforcing layer affixed to the outer side of the aerogel blanket to provide rigidity to the aerogel blanket.

### BACKGROUND OF THE INVENTION

The subject matter herein relates generally to antenna covers having thermal barriers.

Thermal barriers are used to provide thermal protection for electronic components, such as antenna. In some applications, the thermal barriers and electronic components may be used in extreme environments and thus thermal barriers having excellent thermal performance may be needed. Some applications, such as aeronautical applications, may be subject to extremely high temperatures, such as in excess of 400° C. or more, such as in excess of 1,000° C. For example, the antenna may be used for communication or guidance in an aircraft, such as an airplane or missile. Such aircraft travel at high speeds, such as sub-sonic or even super-sonic speeds, creating high friction along the skin of the aircraft, which leads to high temperatures.

Aerogel is a material having very high thermally insulating properties making its use as a thermal barrier in some applications desirable. However, aerogel lacks mechanical stability required for use in certain applications, such as an antenna cover, subjected to the exterior environment of the aircraft. Other materials typically used for antenna covers, such as certain plastic materials, provide sufficient structural rigidity but lack the thermal insulating properties needed to protect the antenna in the high temperature environment. Additionally, the material used for the antenna cover should allow transmission and/or reception of radio frequency signals through the cover layer by the antenna to not negatively or detrimentally impact the RF communication of the antenna.

A need remains for a thermal barrier having excellent thermal properties with sufficient mechanical stability and RF transparency for use in aeronautical applications.

### BRIEF SUMMARY OF THE INVENTION

In one embodiment, an antenna cover is provided for an antenna of an aircraft that includes a thermal barrier having an aerogel blanket having a shape of the antenna cover. The aerogel blanket has an inner side and an outer side with edges therebetween. The inner side is configured to face the antenna. The antenna cover includes a cover layer applied to the aerogel blanket. The cover layer includes at least one polytetrafluoroethylene (PTFE) sheet being a structurally reinforcing layer affixed to the outer side of the aerogel blanket to provide rigidity to the aerogel blanket.

In another embodiment, an antenna cover is provided for an antenna of an aircraft that includes a thermal barrier having an aerogel blanket having a shape of the antenna cover. The aerogel blanket has an inner side and an outer side with edges therebetween. The inner side is configured to face the antenna. The antenna cover includes a first cover layer applied to the aerogel blanket including at least one polytetrafluoroethylene (PTFE) sheet being a structurally reinforcing layer affixed to the outer side of the aerogel blanket to provide rigidity to the aerogel blanket. The antenna cover includes a second cover layer applied to the aerogel blanket including at least one PTFE sheet being a structurally reinforcing layer affixed to the inner side of the aerogel blanket to provide rigidity to the aerogel blanket.

In a further embodiment, an antenna assembly is provided for an aircraft including a base configured to be received in a skin of the aircraft and defining an enclosure with an antenna received in the enclosure. The antenna assembly includes an antenna cover coupled to the base to cover the antenna and the enclosure. The antenna cover includes a thermal barrier including an aerogel blanket having a shape of the antenna cover. The aerogel blanket has an inner side and an outer side with edges therebetween. The inner side is configured to face the antenna. The antenna cover includes a cover layer applied to the aerogel blanket. The cover layer includes at least one polytetrafluoroethylene (PTFE) sheet being a structurally reinforcing layer affixed to the outer side of the aerogel blanket to provide rigidity to the aerogel blanket.

### BRIEF DESCRIPTION OF THE DRAWINGS

FIG. 1 is a sectional view of an antenna assembly in accordance with an exemplary embodiment.

FIG. 2 is a schematic illustration of an antenna cover of the antenna assembly formed in accordance with an exemplary embodiment.

FIG. 3 is an exploded view of the antenna cover shown in FIG. 2.

FIG. 4 is a schematic illustration of an antenna cover of the antenna assembly formed in accordance with an exemplary embodiment.

FIG. 5 is an exploded view of the antenna cover shown in FIG. 4.

### DETAILED DESCRIPTION OF SPECIFIC EMBODIMENTS OF THE INVENTION

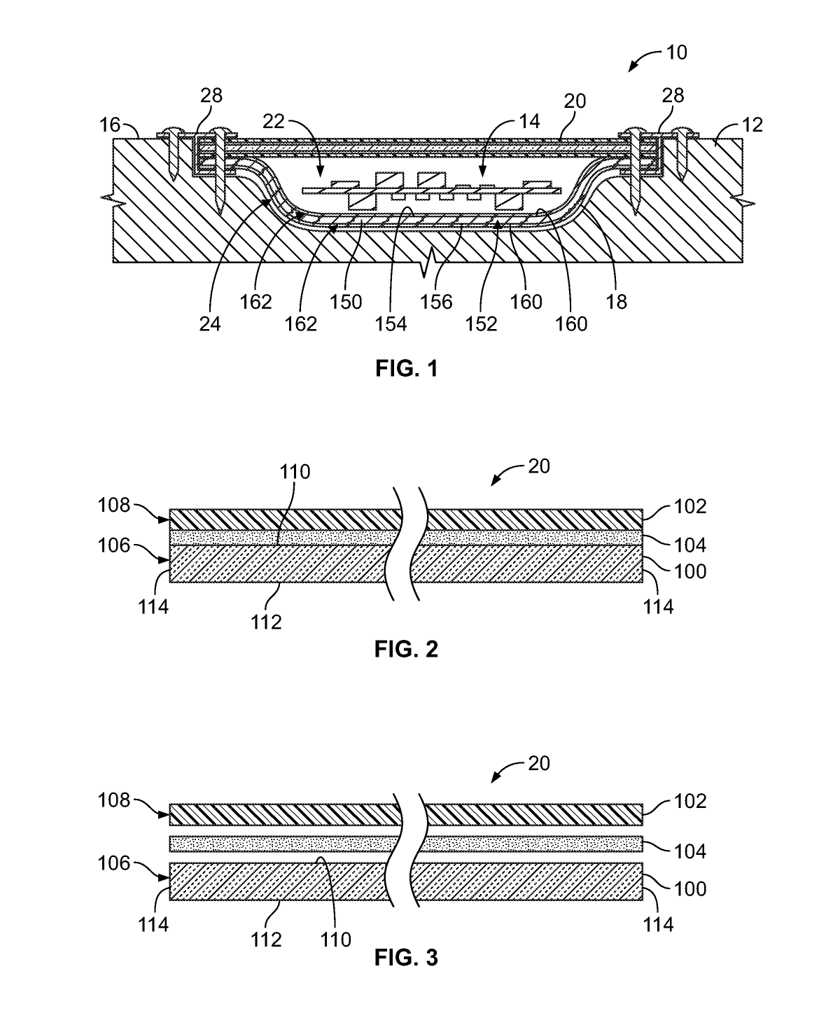

FIG. 1 is a sectional view of an antenna assembly 10 in accordance with an exemplary embodiment. The antenna assembly 10 may be used with a vehicle 12, such as an aircraft; however the antenna assembly 10 is not limited to aeronautical use. The vehicle 12 may be referred to hereinafter as an aircraft 12 and may be any type of aircraft such as an airplane, a missile or another type of aircraft. The aircraft 12 may be subject to extreme environments, such as very high heat, such as heat generated from friction when flying at high speeds, including sub-sonic or super-sonic speeds. For example, the aircraft 12 may be subject to temperatures in excess of 600° C. The electrical components need to be protected from the high temperatures.

In an exemplary embodiment, the antenna assembly 10 includes an antenna 14 housed within the aircraft 12, such as within a skin 16 of the aircraft 12 for data communication and/or guidance of the aircraft 12. The antenna 14 is used for radio frequency (RF) transmission and/or reception. The antenna 14 must be able to transmit and/or receive RF signals and thus the surrounding protective structure must allow the transmission and/or reception of RF signals.

The antenna assembly 10 includes a base 18 and an antenna cover 20 coupled to the base 18. The base 18 defines an enclosure 22 that receives the antenna 14 and other electronic components. The antenna cover 20 covers the antenna 14 and the enclosure 22. The antenna cover 20 protects the antenna 14 and other electronic components, such as from the environment and excessive heat during use. The antenna cover 20 does not prohibit RF signal transmission and reception. The antenna cover 20 is mechanically stiff to close the enclosure 22 from the exterior environment in which the antenna assembly 10 is used. The antenna cover 20 provides a thermal barrier having thermal stability for the antenna 14 and other electronic components in the enclosure 22. The antenna cover 20 is positioned relative to the antenna 14 to protect the antenna 14 from heat. Optionally, the antenna cover 20 may cover one or more sides of the antenna 14. The antenna cover 20 may completely cover the antenna 14. Alternatively, the antenna cover 20 may cover portions of the antenna 14.

In an exemplary embodiment, the antenna assembly 10 is received in a pocket 24 formed in the skin 16 of the aircraft 12. As such, the antenna assembly 10 may be recessed in the aircraft 12. The antenna cover 20 may extend along the antenna assembly 10 such that the antenna cover 20 is generally flush with the exterior surface of the aircraft 12 defined by the skin 16. In the illustrated embodiment, the antenna cover 20 is generally planar; however the antenna cover 20 may have other shapes, such as a bulging convex shape. One or more brackets 28 may be used to secure the antenna assembly 10 in the aircraft 12. The bracket 28 may be a ring configured to be secured to the skin 16 using fasteners or other securing means.

FIG. 2 is a schematic illustration of the antenna cover 20 formed in accordance with an exemplary embodiment. FIG. 3 is an exploded view of the antenna cover 20 shown in FIG. 2. In an exemplary embodiment, the antenna cover 20 is a multi-layer structure including materials providing thermal protection and mechanical stiffness for protecting the antenna 14 (shown in FIG. 1).

The antenna cover 20 includes a thermal barrier 100 and a cover layer 102 covering at least a portion of the thermal barrier 100. An adhesive layer 104 is provided between the thermal barrier 100 and the cover layer 102. In an exemplary embodiment, the adhesive layer 104 is a high temperature film adhesive; however, other types of adhesives may be used in alternative embodiments. Other layers may be provided between the thermal barrier 100 and the cover layer 102 to secure the cover layer 102 to the thermal barrier 100. In other various embodiments, other means, such as use of fasteners or thread sewn between the layers, may be used to secure the cover layer 102 to the thermal barrier 100. The thermal barrier 100 is manufactured from a thermally insulative material to provide thermal protection for the antenna 14. The cover layer 102 is used to provide protection for the thermal barrier 100 and/or the antenna 14.

In an exemplary embodiment, the thermal barrier 100 is manufactured from an aerogel material. For example, the thermal barrier 100 includes an aerogel blanket 106 sized and shaped to form the antenna cover 20. The aerogel blanket 106 includes aerogel particles and fibrous inorganic battings or textile. For example, the aerogel particles may be chemically bound to a ceramic fiber textile. The fibers are flexible and provide a structure that may be rolled, cut, shaped or manipulated to form the base layer of the antenna cover 20. The aerogel particles have super-insulating properties to provide thermal protection and performance at extremely high temperatures. By combining the aerogel particles with the fiber textile, the aerogel blanket is processable and workable, such as for bending, cutting and handling.

The cover layer 102 is applied to the aerogel blanket 106 using the adhesive layer 104. The adhesive layer 104 may be applied directly to the cover layer 102 or to the aerogel blanket 106 and then the structure may be heated and pressed together to form the antenna cover 20. In an exemplary embodiment, the cover layer 102 is manufactured from at least one polytetrafluoroethylene (PTFE) sheet 108. The cover layer 102 may be manufactured from other materials with low RF losses capable of withstanding high temperatures of aeronautical applications while providing sufficient rigidity for defining an exterior skin of an aircraft. The PTFE sheet(s) 108 may be rolled, cut, shaped or otherwise manipulated to the desired shape of the antenna cover 20. Optionally, the cover layer 102 and the thermal barrier 100 may be formed to the desired shape (e.g., cut) after the cover layer 102 is applied to the thermal barrier 100.

The PTFE sheet 108 covers the aerogel blanket 106 to protect the aerogel blanket 106 from the environment. The PTFE sheet 108 is a material capable of withstanding extreme temperatures, such as temperatures in excess of 400° C. or higher, such as in excess of 600° C. The PTFE sheet 108 provides rigidity and stiffness to the antenna cover 20 to limit bending, shifting or other manipulation of the aerogel blanket 106, which could cause aerogel particles to shed or slough off of the thermal barrier 100. Optionally, the cover layer 102 may inhibit dust migration from the aerogel blanket 106 during handling and use. Optionally, the cover layer 102 may wrap entirely around the aerogel blanket 106 and retain the dust within the interior of the cover layer 102.

The aerogel blanket 106 includes an outer side 110, an inner side 112 and edges 114 between the outer and inner sides 110, 112. The aerogel blanket 106 has a thickness defined between the outer side 110 and the inner side 112. The thickness of the aerogel blanket 106 affects the thermal properties of the antenna cover 20, and thus affects a temperature that the antenna cover 20 is able to withstand. For example, an aerogel blanket having a thickness of approximately 10.0 mm may be able to withstand higher temperatures than an aerogel blanket having a thickness of approximately 5.0 mm. Optionally, the outer side 110 and the inner side 112 may be generally planar and parallel; however, the outer side 110 and/or the inner side 112 may be nonplanar and/or nonparallel in alternative embodiments. The aerogel blanket 106 may have a non-uniform thickness in various embodiments. Optionally, the outer side 110 and/or the inner side 112 may have v-shaped grooves or channels formed therein to facilitate wrapping, folding or shaping the antenna cover 20.

The inner side 112 is configured to face inward and thus toward the antenna 14. The outer side 110 is configured to face outward and thus the exterior environment of the antenna cover 20. In the illustrated embodiment, the cover layer 102 is applied to the outer side 110. In other various embodiments, the cover layer 102 may additionally or alternatively be applied to the inner side 112 and/or the edges 114. In an exemplary embodiment, the cover layer 102 and the aerogel blanket 106 are manufactured from materials that do not inhibit communication with the antenna 14, such as RF communication.

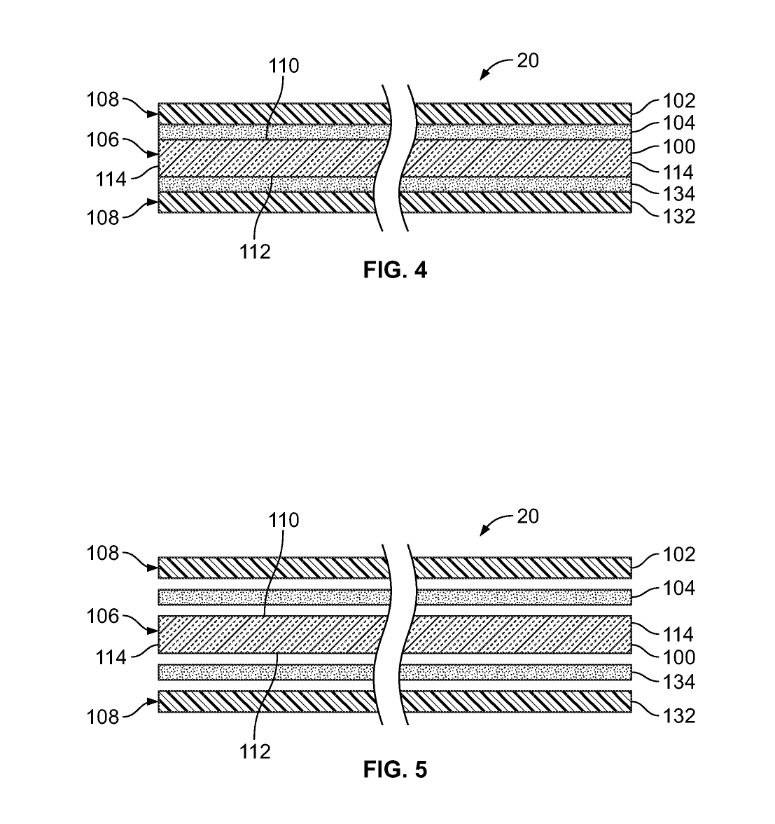

FIG. 4 is a schematic illustration of the antenna cover 20 formed in accordance with an exemplary embodiment. FIG. 5 is an exploded view of the antenna cover 20 shown in FIG. 4. The embodiment of the antenna cover 20 shown in FIGS. 4 and 5 is similar to the embodiment shown in FIGS. 2-3; however the antenna cover 20 shown in FIGS. 4-5 includes multiple cover layers.

The antenna cover 20 includes the thermal barrier 100. The cover layer 102 defines a first cover layer 102 that covers the outer side 110 of the aerogel blanket 106. The antenna cover 20 includes a second cover layer 132 that covers the inner side 112 of the aerogel blanket 106. In an exemplary embodiment, the cover layer 102 is manufactured from at least one polytetrafluoroethylene (PTFE) sheet 108. The adhesive layer 104 is a first adhesive layer 104 provided between the aerogel blanket 106 and the first cover layer 102. A second adhesive layer 134 is provided between the inner side 112 of the aerogel blanket 106 and the second cover layer 132. The cover layers 102, 132 sandwich the aerogel blanket 106 therebetween.

Other layers may be provided in other various embodiments, including multiple aerogel blankets which may be separated by PTFE sheets or layers of other materials, such as an inorganic fabric, a fiberglass fabric, a ceramic fabric, an inorganic film, or another type of structure. The first and second cover layers 102, 132 may be formed from a single PTFE sheet wrapped around the aerogel blanket 106. Alternatively, the first and second cover layers 102, 132 may be formed from different PTFE sheets 108. The first and second cover layers 102, 132 may be connected together, such as through the aerogel blanket 106.

The first and second cover layers 102, 132 provide rigidity and stiffness to the antenna cover 20 to limit bending, shifting or other manipulation of the aerogel blanket 106, which could cause aerogel particles to shed or slough off of the thermal barrier 100. Optionally, the cover layers 102, 132 may inhibit dust migration from the aerogel blanket 106 during handling and use, such as by enclosing or containing the aerogel blanket 106. Optionally, the first cover layer 102 and/or the second cover layer 132 may wrap around the edges 114 and retain the dust within the interior of the cover layers 102, 132.

The second cover layer 132 at the inner side 112 is configured to face inward and thus toward the antenna 14. The first cover layer 102 at the outer side 110 is configured to face outward and thus the exterior environment of the antenna cover 20. In an exemplary embodiment, the cover layers 102, 132 and the aerogel blanket 106 are manufactured from materials that do not inhibit communication with the antenna 14, such as RF communication. Providing two cover layers 102, 132 increases the overall thickness of the PTFE sheets 108 on the antenna cover 20, which may add to the structural rigidity of the antenna cover 20 as compared to an antenna cover that includes a single cover layer 102. Optionally, by using two cover layers 102, 132 rather than a single cover layer 102, the number of PTFE sheets 108 in each cover layer 102 or 132 may be less than the number of PTFE sheets 108 in the single cover layer 102 or thinner PTFE sheets 108 may be used, which may reduce the cost of the cover layers 102, 132.

With reference back to FIG. 1, the antenna cover 20 and the base 18 are illustrated. Optionally, the base 18 may be manufactured similar to the antenna cover 20. For example, the base 18 may include a thermal barrier 150 including an aerogel blanket 152 having an inner side 154 and an outer side 156. The inner side 154 of the aerogel blanket 152 of the base 18 faces the antenna 14. The base 18 includes a cover layer 160 applied to the aerogel blanket 152 of the base 18. The cover layer 160 includes at least one PTFE sheet 162 being a structurally reinforcing layer affixed to the aerogel blanket 152 to provide rigidity to the aerogel blanket 152. In the illustrated embodiment, cover layers 160 are affixed to both the inner side 154 and the outer side 156; however, in other embodiments, the cover layer 160 may be affixed to either the inner side 154 or the outer side 156.

Embodiments are described herein of an antenna cover 20 manufactured from an aerogel blanket 106 having excellent thermal properties and a one or more PTFE sheets 108 providing mechanical stiffness to the aerogel blanket 106 while allowing RF transmission therethrough. The cover layer 102 formed by the PTFE sheets 108 protects the aerogel blanket 106 and the antenna 14 and provides sufficient mechanical stiffness to be an exterior surface of the skin of the aircraft. The cover layer 102 is capable of withstanding high temperatures and the thermal barrier 100 defined by the aerogel blanket 106 protects the antenna 14.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112(f), unless and until such claim limitations expressly use the phrase “means for” followed by a statement of function void of further structure.

What is claimed is:

1. An antenna cover for an antenna of an aircraft comprising:
a thermal barrier comprising an aerogel blanket having a shape of the antenna cover, the aerogel blanket having an inner side and an outer side with edges therebetween, the inner side configured to face the antenna; and
a cover layer applied to the aerogel blanket, the cover layer including at least one polytetrafluoroethylene (PTFE) sheet being a structurally reinforcing layer affixed to the outer side of the aerogel blanket to provide rigidity to the aerogel blanket.

2. The antenna cover of claim 1, wherein the cover layer allows at least one of transmission and reception of radio frequency signals through the cover layer by the antenna.

3. The antenna cover of claim 1, wherein the PTFE sheet is applied to the aerogel blanket using a high temperature film adhesive.

4. The antenna cover of claim 1, further comprising an adhesive layer between the cover layer and the thermal barrier, the adhesive layer comprising a high temperature film adhesive.

5. The antenna cover of claim 1, wherein the cover layer is a first cover layer, the antenna cover further comprising a second cover layer applied to the aerogel blanket, the second cover layer including at least one PTFE sheet being a structurally reinforcing layer affixed to the inner side of the aerogel blanket to provide rigidity to the aerogel blanket.

6. The antenna cover of claim 5, wherein the aerogel blanket is sandwiched between the first and second cover layers.

7. The antenna cover of claim 5, wherein the first and second cover layers cover both the inner and outer sides to inhibit dust migration from the aerogel blanket to the antenna.

8. The antenna cover of claim 5, wherein at least one of the first cover layer and second cover layer wrap around the edges to completely enclose the aerogel blanket.

9. The antenna cover of claim 1, wherein the cover layer comprises a plurality of PTFE sheets.

10. An antenna cover for an antenna of an aircraft comprising:
a thermal barrier comprising an aerogel blanket having a shape of the antenna cover, the aerogel blanket having an inner side and an outer side with edges therebetween, the inner side configured to face the antenna;
a first cover layer applied to the aerogel blanket, the first cover layer including at least one polytetrafluoroethylene (PTFE) sheet being a structurally reinforcing layer affixed to the outer side of the aerogel blanket to provide rigidity to the aerogel blanket; and
a second cover layer applied to the aerogel blanket, the second cover layer including at least one PTFE sheet being a structurally reinforcing layer affixed to the inner side of the aerogel blanket to provide rigidity to the aerogel blanket.

11. The antenna cover of claim 10, wherein the cover layer allows at least one of transmission and reception of radio frequency signals through the cover layer by the antenna.

12. The antenna cover of claim 10, wherein the PTFE sheet is applied to the aerogel blanket using a high temperature film adhesive.

13. The antenna cover of claim 10, wherein the first and second cover layers cover both the inner and outer sides to inhibit dust migration from the aerogel blanket to the antenna.

14. The antenna cover of claim 10, wherein at least one of the first cover layer and second cover layer wrap around the edges to completely enclose the aerogel blanket.

15. The antenna cover of claim 10, wherein the cover layer comprises a plurality of PTFE sheets.

16. An antenna assembly for an aircraft comprising:
a base configured to be receive in a skin of the aircraft, the base defining an enclosure;
an antenna received in the enclosure; and
an antenna cover coupled to the base to cover the antenna and the enclosure, the antenna cover including a thermal barrier comprising an aerogel blanket having a shape of the antenna cover, the aerogel blanket having an inner side and an outer side with edges therebetween, the inner side configured to face the antenna, the antenna cover including a cover layer applied to the aerogel blanket, the cover layer including at least one polytetrafluoroethylene (PTFE) sheet being a structurally reinforcing layer affixed to the outer side of the aerogel blanket to provide rigidity to the aerogel blanket.

17. The antenna assembly of claim 16, wherein the cover layer allows at least one of transmission and reception of radio frequency signals through the cover layer by the antenna.

18. The antenna assembly of claim 16, wherein the base comprises a thermal barrier comprising an aerogel blanket having an inner side and an outer side, the inner side of the aerogel blanket of the base configured to face the antenna, the base including a cover layer applied to the aerogel blanket of the thermal barrier of the base, the cover layer of the base including at least one PTFE sheet being a structurally reinforcing layer affixed to the aerogel blanket to provide rigidity to the aerogel blanket.

19. The antenna assembly of claim 16, wherein the cover layer of the base is affixed to the inner side of the aerogel blanket of the thermal barrier of the base.

20. The antenna assembly of claim 16, further comprising a bracket secured to the skin of the aircraft and holding the base and the antenna cover.
